(19) United States
(12) Patent Application Publication
(10) Pub. No.: US 2005/0224579 A1
(43) Pub. Date: Oct. 13, 2005

(54) System and methods for generating bar codes in a distributed computing environment

(76) Inventor: Steve Adler, Providence, RI (US)

Correspondence Address: EDWARDS & ANGELL, LLP, P.O. BOX 55874, BOSTON, MA, 02205, US

(21) Appl. No.: 11/101,767

(22) Filed: Apr. 8, 2005

Related U.S. Application Data
(60) Provisional application No. 60/560,474, filed on Apr. 8, 2004.

(51) Int. Cl. G06K 7/10

(52) U.S. Cl. 235/462.01

(57) ABSTRACT

A Web based bar code system uses the “seeds” of Code 39 barcodes to create full size, reliable and scannable barcodes when printed from a Web browser with out the need for any special software either on the client's browser or the Web server. The technique passes only the very smallest logical unit of a bar code image across the Internet. The native resizing of images ability built into Web browsers concatenate and stretch the seeds to the desired size. For example, the bandwidth required to display and print large numbers of codes is minimized because the seeds are tiny, sizing in at about 45 bytes per character.

### CROSS-REFERENCE TO RELATED APPLICATION

This application claims priority to U.S. Provisional Patent Application No. 60/560,474, filed Apr. 8, 2004, which is incorporated herein by reference.

### BACKGROUND OF THE INVENTION

1. Field of the Invention

The subject disclosure relates to constructing bar codes, and more particularly to an improved system and method for storing, constructing and transmitting bar codes in a distributed computing environment.

2. Background of the Related Art

Barcodes are machine readable representations of information. Typically, a barcode consists of parallel lines of varying widths and spacing that can be read by an optical scanning device. The optical scanning device is typically referred to as a barcode reader, such an example of which can be found in U.S. Pat. No. 6,814,291 which is incorporated herein by reference. Use of barcodes has been widely used and well understood in the art.

The use of barcodes has also extended to the Internet. One approach has been to use barcode font installed on a client computer. The barcodes can be referenced from the client computer as any font can be used. Another approach has been to utilize precompiled barcode images. This approach allows preprocessing of fully enabled bar code images. In this approach, a server based component would create a barcode image and send the barcode image to the user's browser as a complete, single image with pixel dimensions exactly equal to the size of the completed bar code.

There are problems associated with the approaches above. The barcode font approach requires the license and installation of an additional piece of software that usually requires that the barcode font can only be used on the particular computer in which the barcode font was installed. Use on say, a public library's computer would show large numbers in the place that the bar codes should appear. The precompiled barcode images have other drawbacks. If the barcode is large, the corresponding barcode image would have to be large. Generally, resizing these bar codes would ruin the integrity of the barcode, so the barcode image needs to be produced in exactly the intended size of use. The license and installation of a third party component for running on the Web server (to create the barcode images) adds expense and costs valuable computing time.

### SUMMARY OF THE INVENTION

In view of the above, there is a need, therefore, for an improved system and method for utilizing the Internet to allow easy and efficient generation and distribution of barcodes.

It is an object of the present disclosure to combine the benefits of the barcode font approach and precompiled barcode image approach. The subject technology offers clean, resizable fonts with Internet bandwidth efficiency so that users can produce barcodes without the need for additional installed fonts or software. Further, the subject invention preferably is lightweight in that no installed components are required on the server or client side.

One embodiment of the subject disclosure is directed to a server for facilitating use of barcodes in a distributed computing network, wherein the server communicates with a client computer via the distributed computing network. The server includes a memory storing an instruction set and a plurality of barcode seeds and a processor for running the instruction set, the processor being in communication with the memory and the distributed computing network. The processor is operative to concatenate at least two barcode seeds that are selected from the plurality of barcode seeds and provide the concatenated string of at least two barcode seeds to a user.

The subject disclosure is also directed to a method for utilizing barcodes for data entry, wherein a plurality of clients communicate in a distributed computing network. The method includes optimizing a set of barcode seeds for transmission across the distributed computing network, transmitting the set of barcode seeds to the plurality of clients, concatenating at least two barcode seeds to form a barcode representing data and resizing the barcode.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a diagram showing an environment for transmitting bar codes in accordance with the subject disclosure.

FIG. 2 is a schematic view of a server for use in the environment of FIG. 1.

FIG. 3 is an illustrative table showing graphically a sampling of barcode seeds in accordance with the subject disclosure.

FIG. 4 is a barcode seed magnified for illustration in accordance with the subject disclosure.

FIG. 5 is a barcode constructed in accordance with the subject disclosure.

FIG. 6 is a flow diagram of a process performed to transmit bar codes in accordance with the subject disclosure.

### DETAILED DESCRIPTION OF PREFERRED EMBODIMENTS

The present invention overcomes many of the prior art problems associated with barcodes in a distributed computing network. The advantages, and other features of the systems and methods disclosed herein, will become more readily apparent to those having ordinary skill in the art from the following detailed description of certain preferred embodiments taken in conjunction with the drawings which set forth representative embodiments of the present invention and wherein like reference numerals identify similar structural elements whenever possible.

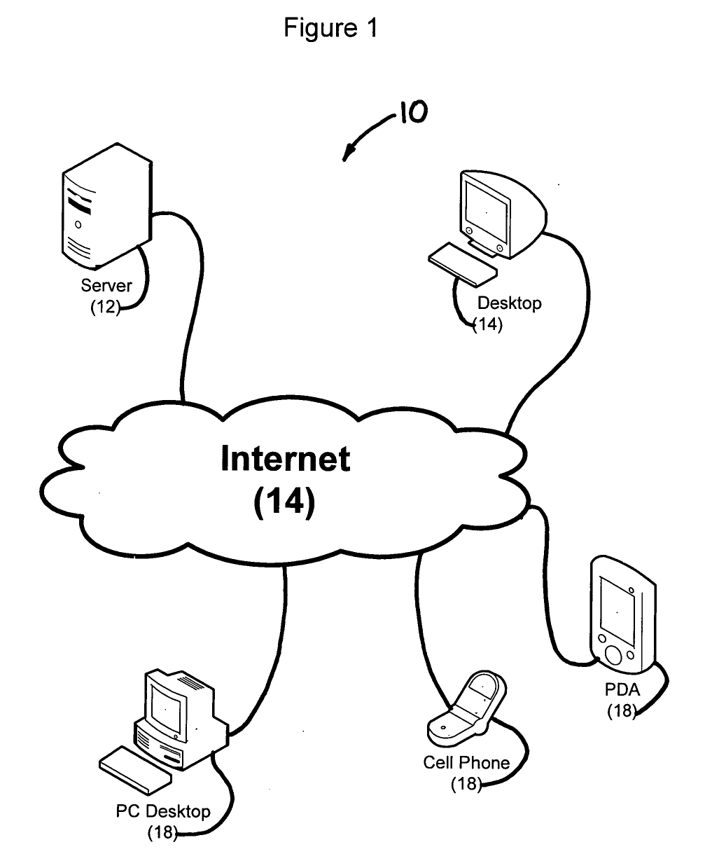

Referring now to the FIG. 1, there is shown a block diagram of an environment 10 for implementing the methodology of the present disclosure. In the environment 10, a plurality of users can utilize barcodes for data entry and other applications.

The barcodes are substantially optimized for efficient electronic transmission from location to location so that minimal bandwidth is necessary. The following discussion describes the structure of such an environment 10 but further discussion of the application programs, data modules and barcode seeds that embody the methodology of the present invention is described elsewhere herein as would be appreciated by those of ordinary skill in the pertinent art.

Referring still to FIG. 1, distributed computing network 14 may include any number of network systems well known to those skilled in the art. The distributed computing network 14 can be a series of network nodes that can be interconnected by network devices and communication lines (e.g., public carrier lines, private lines, satellite lines, etc.) that enable the network nodes to communicate. The transfer of data (e.g., messages containing barcode seeds) between network nodes can be facilitated by network devices such as routers, switches, multiplexers, bridges, gateways, and the like that can manipulate and/or route data from an originating node to a destination node regardless of any dissimilarities in the network topology (e.g., bus, star, token ring and the like), spatial distance (e.g., local, metropolitan, wide area network and the like), transmission technology (e.g., TCP/IP, Systems Network Architecture and the like), data type (e.g., data, voice, video, multimedia and the like), nature of connection (e.g., switched, non-switched, dial-up, dedicated, virtual and the like), and/or physical link (e.g., optical fiber, coaxial cable, twisted pair, wireless and the like) between the originating and destination network nodes. For example, distributed computing network 14 may be a combination of local area networks (LAN) and wide area networks (WAN) as is well known.

In a preferred embodiment, the distributed computing network 14 is the Internet. For the Internet, the preferred method of accessing information is the World Wide Web because navigation is intuitive and does not require technical knowledge. In another embodiment, the distributed computing network 14 is a local area network operated by a company. The environment 10 includes one or more servers 12 which communicate with a distributed computing network 14 via communication channels, whether wired or wireless, as is well known to those of ordinary skill in the pertinent art. For simplicity, one server 12 is shown. On the Internet, a plurality of clients 18 can interactively communicate with the server 12 and on a client to client basis.

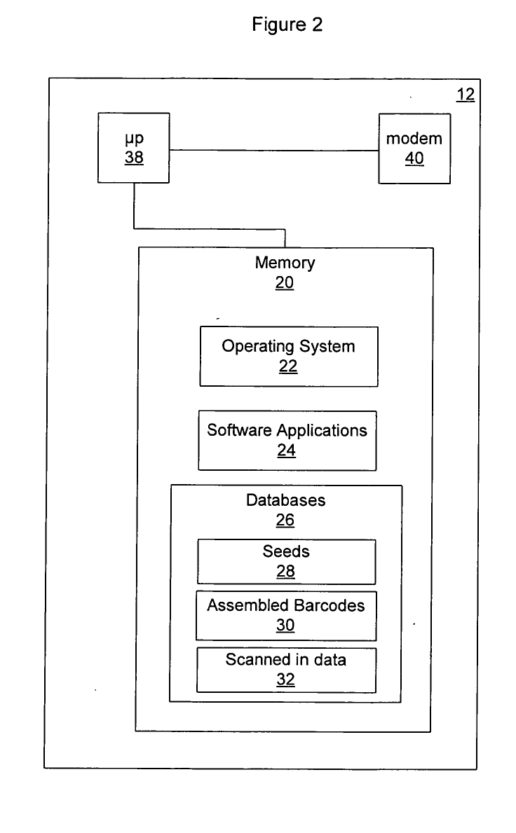

Referring now to FIG. 2, server 12 hosts multiple Web sites and houses multiple databases necessary for the proper operation of the methods and systems in accordance with the subject invention. The server 12 is any of a number of servers known to those skilled in the art that are intended to be operably connected to a network so as to operably link to the plurality of clients 18 via the distributed computing network 14. As illustration, the server 12 typically includes a central processing unit or cpu 38 including one or more microprocessors such as those manufactured by Intel or AMD and memory 20 operatively connected to the cpu 38. The memory 20 can be any combination or variety appropriate for electronics, such as read-only memory (ROM), programmable read-only memory (PROM), erasable programmable read-only memory (EPROM), random access memory (RAM), dynamic random access memory (DRAM), static random access memory (SRAM), non-volatile random access memory (NVRAM), magnetizable media, combinations thereof, or other types of memory well known to those skilled in the art.

The memory 20 of the server 12 may be used for storing an operating system 22, software applications 24 for execution on the central processing unit 38, an area 26 for storing databases and the like. The memory 20 of the server 12 also typically controls booting and storing the operating system 22, as well as other applications or systems that are to be executed on the server 12 such as paging and swapping between the hard disk and the RAM. Software, code or software applications 24 generally refer to computer instructions which, when executed on the cpu 38, cause interactions with operating parameters, sequence data/parameters, database entries, network connection parameters/data, variables, constants, software libraries, and/or any other elements needed for the proper execution of the instructions, within an execution environment in the memory 20 of the server 12. Those of ordinary skill will recognize that the software applications 24 and various processes discussed herein are merely exemplary of the functionality performed by the disclosed technology and thus such processes and/or their equivalents may be implemented in commercial embodiments in various combinations and quantities without materially affecting the operation of the disclosed technology.

The server 12 also includes other mechanisms and structures for performing I/O operations such as disk drives (not shown) and a modem 40 for communicating with the distributed computing network 14. It is envisioned that the server 12 can utilize multiple servers in cooperation to facilitate greater performance and stability of the subject invention by distributing memory and processing as is well known. U.S. Pat. No. 5,953,012 to Venghte et al. describes a method and system for connecting to, browsing and accessing computer network resources and is herein incorporated by reference in its entirety. Additionally, U.S. Pat. No. 5,708,780 to Levergood et al. describes an Internet server which controls and monitors access to network servers and is also herein incorporated by reference in its entirety as proper security measures are also envisioned within the environment 10.

Referring again to FIG. 1, the environment 10 also includes a plurality of input/output devices as the clients 18 such as desktop computers, laptop computers, personal digital assistants, cellular telephones, cash registers and the like. The clients 18 communicate with the distributed computing network 14 to allow users to access information on the server 12. For simplicity, only three clients 18 are shown. Some clients 18 are also capable of being interconnected directly to server 12 as would be known to those of ordinary skill in the art.

The clients 18 have output devices such as displays and printer as well as input devices as would be appreciated by those of ordinary skill in the pertinent art. The display may be any of a number of devices known to those skilled in the art for displaying images responsive to outputs signals from the clients 18. Such devices include but are not limited to cathode ray tubes (CRT), liquid crystal displays (LCDS), plasma screens and the like. Although somewhat simplified and schematic diagrams are illustrated, such illustration shall not be construed as limiting the present disclosure to the illustrated embodiment. It should be recognized that the signals being outputted from the clients 18 can originate from any of a number of devices including PCI or AGP video boards or cards mounted within housings of the clients 18 that are operably coupled to the microprocessors and the displays of the clients 18. Preferably, the clients 18 also include a graphics card for that permits the clients 18 to display pictures.

Clients 18 typically provide administrative access to the environment 10 so that an entity, usually a company, can implement and use the subject methodology. A plurality of users may share the same client 18 and cookie technology can be utilized to facilitate access to the environment 10 and, thereby, use of barcode seeds in accordance with the subject disclosure. A plurality of users can utilize the environment 10 simultaneously.

The input devices of the clients 18, as is known to those skilled in the art, can be used to provide input signals for control of applications programs and other programs such as the operating system being executed on the clients 18. Preferably, the clients 18 include a barcode scanning device (not shown) and the ability to print barcodes as would be well known to those of ordinary skill in the pertinent art. In illustrative embodiments, the input devices include a switch, a slide, a mouse, a track ball, a glide point or a joystick, a microphone or other such device (e.g., a keyboard having an integrally mounted glide point or mouse) by which a user such as a consumer can input control signals and other commands. Although the use of a keyboard as an input device for the server 12 and clients 18 is not described further herein, it is within the scope of the present invention for the input device to comprise any of a number of input means known to those skilled in the art, wherein the control signals or commands for implementing and interacting with the environment 10 and the applications program embodying such methodology can be implemented in the form of discrete commands from an input device. Similarly, each client 18 simply connect to a printer (not shown) for generating barcodes, items that incorporate barcodes and the like.

The clients 18 typically include a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of the clients 18 is for purposes of booting and storing the operating system, other applications or systems that are to be executed on the computer, paging and swapping between the hard disk and the RAM and the like. In one embodiment, the application programs reside on the hard disk drive for performing the functions in accordance with the subject disclosure. In another embodiment, the hard disk drive simply has a browser for accessing an application hosted within the distributed computing network 14. The clients 18 can also utilize a removable computer readable medium such as a CD or DVD type of media that is inserted therein for reading and/or writing to the removable computer readable media. As can be seen from the above, the clients 18 and server 12 could be interchangeable. Thus, a schematic diagram of a client 18 would indeed be functionally equivalent to the server 12 of FIG. 2 although one is not included herein and, for simplicity, several components are not shown.

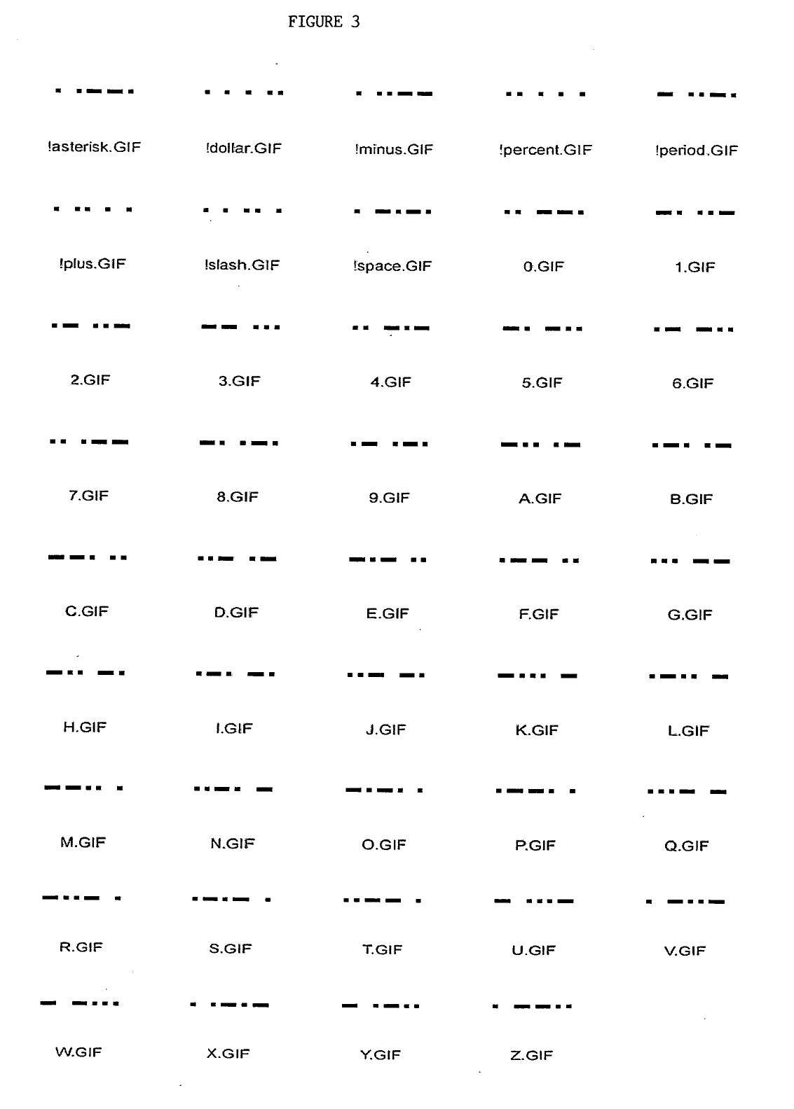

Referring now to FIGS. 2 and 3, the area 26 for storing databases includes a database 28 of barcode seed files. In this preferred embodiment, the barcode seed database 28 stores a set of forty-four optimized bar code seed files. Of course the set can include an infinite amount of files representing characters but, for simplicity, a representative sampling is graphically shown in FIG. 3. The barcode seeds represented by the forty-four files include the characters 0-9, A-Z and a few special characters supported by the Code 39 standard. By using escape characters, lower case and other characters are easily provided.

The barcode seed files are optimized information so that a barcode can be efficeintly represented. Preferably, each barcode seed is a graphic image seventeen pixels wide by one pixel high. Typically, the dimension of 17 by 1 pixel is the minimum representation necessary for a computer image file to sufficiently represent a barcode seed. In other words, the 17 pixel width is preferably the minimum number of pixels required to represent the logical and required order of the black and white sequence needed to uniquely identify a Code 39 barcode. The one pixel height is the minimum height necessary for this information as well. Additionally, the barcode seed files are optimized by setting the color depth attributes within the GIF file to the minimum required by the GIF standard. As a result, extraneous color table information does not need to be encoded in the GIF file, i.e. no space is wasted since only black and white is required to function. In short, the smaller the size of the barcode seed file, the more optimized the barcode seed file is to produce full size, stretchable barcodes.

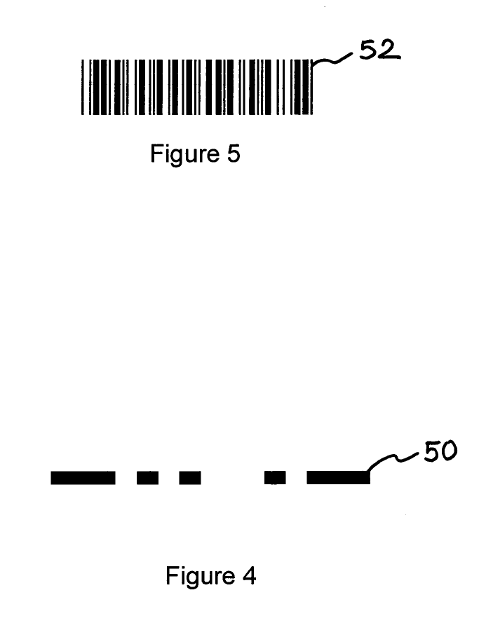

Referring to FIG. 4, a barcode seed 50 representing the character “A” is shown magnified approximately 1600% for illustration. In still another embodiment, the pixel height of the seeds is 2, 10, 25 or the like. A pixel height of 25 has some advantages in that the seeds are tall enough to be used as scanable barcodes without explicit stretching by using a height call in HTML, i.e. the native image height is usable. Similarly, the pixel width of the seeds can be varied. In another embodiment, the seeds are not saved in strictly black and white but are set to 65 k colors or some variation thereof. Further, the width may be similarly varied as may be specific for certain applications.

Still referring to FIGS. 2 and 3, the area 26 for storing databases includes a database 30 of files representing assembled barcodes, documents having assembled barcodes and the like. A set of instructions in the software application database 24 can be used to assemble barcodes of a plurality of characters from the smallest logical unit that can represent a bar code letter. When strung together or concatenated with a small piece of code, one can produce a string of seeds that will produce a valid bar code, using as little as 147 bytes.

In a preferred embodiment, the HTML required to produce a barcode for the word “BARCODE” is as follows:
. . .
<IMG SRC=“barcodes/Asterisk.gif” WIDTH=“17” HEIGHT=“28”>
<IMG SRC=“barcodes/B.gif” WIDTH=“17” HEIGHT=“28”>
<IMG SRC=“barcodes/A.gif” WIDTH=“17” HEIGHT=“28”>
<IMG SRC=“barcodes/R.gif” WIDTH=“17” HEIGHT=“28”>
<IMG SRC=“barcodes/C.gif” WIDTH=“17” HEIGHT=“28”>
<IMG SRC=“barcodes/O.gif” WIDTH=“17” HEIGHT=“28”>
<IMG SRC=“barcodes/D.gif” WIDTH=“17” HEIGHT=“28”>
<IMG SRC=“barcodes/E.gif” WIDTH=“17” HEIGHT=“28”>
<IMG SRC=“barcodes/Asterisk.gif” WIDTH=“17” HEIGHT=“28”>
. . .
While the code to create barcodes can be created in virtually any standard language, an example in ASP to illustrate the usage is as follows:
Dim BarCode
‘This example will turn the word “BARCODE” into a barcode BarCode=“BARCODE”
   ‘Define your barcode dimensions here:
Const SeedWidth=17
Const SeedHeight=28
   ‘Start bar code with a required “*”
   Response.write “<img src=” “barcodes/Asterisk.gif” “WIDTH=” & SeedWidth & “HEIGHT=” & SeedHeight & “>”
   ‘Loop through and construct the needed seeds:
For i=1 to Len(BarCode)
   ConstructString=mid(BarCode,i,1)
   Response.Write “<img src=” “barcodes/” & ConstructString & “.gif” “WIDTH=” & SeedWidth & “HEIGHT=” & SeedHeight & “>” Next
      ‘End with a required “*”
      Response.write “<img src=” “barcodes/Asterisk.gif” “WIDTH=” & SeedWidth & “HEIGHT=” & SeedHeight & “>”
      The code above simply cycles through the letters of the barcode target and creates the required HTML code. In another embodiment, the seeds are structured to comply with a different barcode standard.

When assembled, the barcodes are stored in the assembled barcode database 30 of server 12. As is explained further below, the assembled barcodes may be stored simply, in combination with other information or as part of a larger file as is within the skill of those in the pertinent art.

In the Internet embodiment, the clients 18 also include a Web browser software application (Web browser for short) to locate and display Web pages. In one embodiment, after the barcodes are assembled by the server 12, the server 12 transmits the assembled barcodes to one or more clients 18. A Web browser allows a user of the respective client 18 to print real, scanable bar codes without the need to download any special software or font. By transmitting the seeds or small logical graphical representations of a valid barcode to the clients 18, the Web browser is responsible for formatting the size of the bar codes to a size that is suitable for scanning. The inherent behavior of a Web browser to stretch the minimized barcode seeds can be advantageously used to produce barcodes of any size without wasting Internet bandwidth. As a result, the most bandwidth efficient barcodes are used for distribution via the Internet while still being able to easily produce normal barcodes. No special fonts are required nor are special DLLs needed to run on the server 12 or clients 18. Further, the client's Web browser does not require a plug-in. Further, the client's Web browser can save the images to allow future use as well.

Referring to FIG. 5, an example of a barcode 52 that has been strung together and resized by a client's Web browser is shown. Preferably, the code to concatenate the barcode is written in JavaScript as would be well within one of ordinary skill in the pertinent art based upon review of the subject disclosure. Because the client's Web browser resizes the barcode seeds to make printable and scannable bar codes, the resizing does not create any additional bandwidth or burden on the Web system to produce small barcodes or huge barcodes. The barcode seeds will stretch and still be scannable anywhere within the tolerances of the scanning device. As a result, the barcode 50 can be produced at any size and would still only use about 47 bytes per character and the client 18 does not require an dynamic link libraries (DLLs hereinafter) or additional software. Alternatively, the barcode 52 could have beed concatenated by the server 12 prior to transmitting the barcode seed. Generally in the Code 39 standard, an asterisk is required as a first and last character. Thus, if the server 12 were to send a single seed under Code 39, three characters (e.g., “*A*”) are sent. Of course, under different standards, any number of barcode seeds may be sent individually for concatenation at the client 18 or concatened by the server 12 for resizing by the client 18.

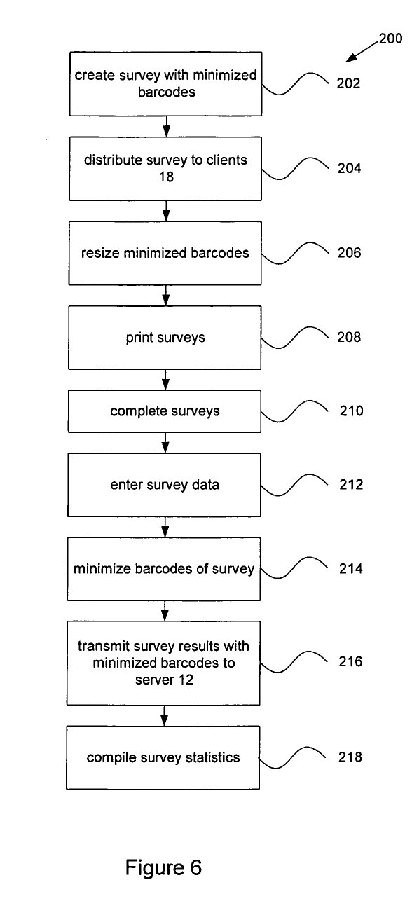

Referring now to FIG. 6, there is illustrated a process 200 that utilizes barcode seeds in accordance with an embodiment of the present disclosure. The process 200 relates to taking surveys over a wide geographic area. Initially, the surveys must be distributed so that information can be gathered. After completion of the surveys, it is necessary to efficiently enter the data. As a result of this transition of data from a source, e.g., server 12, to a wide range of users outside the environment 10, then compiling the data back into the environment 10, the methodology of the subject disclosure is advantageously applied.

At step 202 of process 200, an entity creates survey that is stored on server 12. In a preferred embodiment, the entity does not own and operate the server 12 but pays a fee for usage. It is envisioned that the survey would be saved in the assembled barcode database 30. The survey would include potential responses compiled into barcodes created from barcode seeds.

At step 204, the surveys with minimized barcodes are transmitted to the clients 18 over the distributed computing network 14, e.g., the Internet. The clients 18 could be located within a small geographic region, a country or spread over the world. As a result of the minimization of the barcodes, the process 200 advantageously uses relatively little bandwidth of the distributed computing network 14 for transmission. At step 206, in order to utilize the surveys, each client 18 is able resize the minimized barcodes by using a Web browser as described above. If the survey is taken at the client 18, the barcodes can remain minimized. However, if a hard copy of the survey is required, the survey is printed with readable barcodes at step 208. Preferably, a user at the client 18 creates additional barcodes on the survey for identifying the person who took the survey. Of course, the barcode identifying the person may be created after completion of the survey.

At step 210, the surveys are completed. Preferably, the response are notations made on the survey that correspond to barcodes. The corresponding barcodes contain the response information so that the survey data can be simply entered at step 212 by using a barcode reader. The barcode reader allows quick, easy, and accurate entry of the data from the printed survey into the respective client 18. At step 214, in order to consolidate the survey data, the client 18 minimizes the barcodes that represent the response data for transmission to the server 12 over the distributed computing network 14 at step 216.

At step 218, as the survey responses come in to the server 12 where the results are compiled and stored in the scanned in data database 32. As would be appreciated by those of ordinary skill in the pertinent based upon review of the subject disclosure, the process 200 allows creating a single Web site for distribution of a survey. The survey is efficiently transmitted across the Internet on a global basis. By using a Web browser, the barcodes of the survey can be resized and printed to allow for subsequent response selection by highlighting or circling of a barcode. The data entry is by a barcode reader. As a result, data is collected in a simple, reliable and efficient manner.

In another embodiment, the subject methodology is used for inventory control within a distributed point of sale system where barcodes are used on labels to identify products. The products may even include owner information in a consignment arrangement. In another embodiment, the subject methodology is used to provide an attendance system. By scanning tickets or identification cards with barcodes, attendance for an event or membership organization is tracked without unnecessarily encumbering the transmission bandwidth of the environment. Security is still another application in which credentials are verified by a personal barcode contained on a card. The personal barcode would be unique to the holder and cross-reference to additional data stored in the server 12. Further information such as time and date of the person being in a certain location and the like could also be stored within person's history. The growing wireless capability of the Internet allows such personnel tracking on an ad hoc basis at almost any location using the subject methodology. For example, in volunteer management, a volunteer is assigned a barcode and their credentials can be varied at any location.

It will be appreciated by those of ordinary skill in the pertinent art that the functions of several elements may, in alternative embodiments, be carried out by fewer, or a single element. Similarly, in some embodiments, any functional element may perform fewer, or different, operations than those described with respect to the illustrated embodiment. Also, functional elements (e.g., modules, databases, interfaces, computers, servers and the like) described as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

1. A server for facilitating use of barcodes in a distributed computing network, wherein the server communicates with a client computer via the distributed computing network, and wherein the server comprises:
(a) a memory storing an instruction set and a plurality of barcode seeds; and
(b) a processor for running the instruction set, the processor being in communication with the memory and the distributed computing network, wherein the processor is operative to:
(i) concatenate at least two barcode seeds that are selected from the plurality of barcode seeds; and
(ii) provide the concatenated string of at least two barcode seeds to a client computer.

2. A server as recited in claim 1, wherein the barcode seeds are optimized.

3. A server as recited in claim 1, wherein a Web browser running on the client computer resizes the concatenated string.

4. A server as recited in claim 1, wherein each barcode seed is a graphic image seventeen pixels wide by one pixel high.

5. A server as recited in claim 1, wherein each barcode seed is Code 39 compliant.

6. A server as recited in claim 1, wherein each barcode seed has color depth attributes set to the minimum required by a standard.

7. A method for utilizing barcodes for data entry, wherein a plurality of clients communicate in a distributed computing network, the method comprising the steps of:
(a) optimizing a set of barcode seeds for transmission across the distributed computing network;
(b) transmitting the set of barcode seeds to the plurality of clients;
(c) concatenating at least three barcode seeds to form a barcode representing data; and
(d) resizing the barcode.

8. A method as recited in claim 7, wherein the distributed computing network is the Internet and a client browser resizes the barcode.

9. A method as recited in claim 7, further comprising the step of storing the barcode seeds on a server.

10. A method as recited in claim 7, further comprising the step of storing the barcode seeds on the plurality of clients.

11. A method as recited in claim 7, wherein a first character and a last character of the at least three barcode seeds are asterisks.

12. A server for facilitating use of barcodes in a distributed computing network, wherein the server communicates with a plurality of clients via the distributed computing network, and wherein the server comprises:
(a) a memory storing an instruction set and a plurality of barcode seeds; and
(b) a processor for running the instruction set, the processor being in communication with the memory and the distributed computing network, wherein the processor is operative to:
(i) optimizing a set of barcode seeds for transmission across the distributed computing network;
(ii) transmitting at least one of the set of barcode seeds to a client; and
(iii) resizing the barcode by the client without additional DLLs or software other than a Web browser.

13. A server as recited in claim 1, wherein the set of barcode seeds includes all possible Code 39 characters.

14. A server as recited in claim 1, wherein each barcode seed is a graphic image seventeen pixels wide by one pixel high.
